(19) United States
(12) Patent Application Publication
(10) Pub. No.: US 2008/0253078 A1
(43) Pub. Date: Oct. 16, 2008

(54) Mounting for a computer component

(76) Inventor: Wilhelm Neukam, Bobingen (DE)

Correspondence Address: NEXSEN PRUET, LLC, P.O. BOX 10648, GREENVILLE, SC, 29603, US

(21) Appl. No.: 12/082,186

(22) Filed: Apr. 9, 2008

(30) Foreign Application Priority Data
Apr. 10, 2007 (DE) 102007016903.7

(51) Int. Cl. G06F 1/16

(52) U.S. Cl. 361/685

(57) ABSTRACT

The invention relates to a mounting for a slide-in computer component. Attachment device (10) is provided, which fixes a computer component in a slide-in shelf of a computer housing, and which is arranged on a side wall at the slide-in shelf of the housing. The attachment device comprises at least one spring-mounted latching bolt (40), where the attachment device (10) is designed so that, by sliding the slide-in component into the slide-in shelf, it applies pre-tension to the spring-mounted latching bolt (40), and it holds it by spring force, when the end position is reached, in a bore hole (50) of the component housing (20).

### FIELD OF THE INVENTION

The invention relates to a housing for a computer with a slide-in shelf mounting for a slide-in component housing and to an attachment mechanism which locks the component in position.

### BACKGROUND AND PRIOR ART

A slide-in shelf for mounting a computer is provided preferably for the purpose of receiving a slide-in housing for a computer component. The slide-in housing should be attached using the shelf and attachment device, both to facilitate an error-free function and to prevent unintentional removal. To achieve this, an attachment device is provided. As an attachment device, one can use, for example, a screw connection, which is in an effective connection through a bore on a side wall of the slide-in shelf with a threaded bore on the slide-in housing for computer components. Computer components are, for example, hard disks, diskette drives, CD drives, interface modules, or similar parts. For a simple installation, these cards or cassettes are slid into slide-in shelf or slot of a computer housing and fixed there. The fixation occurs by means of the aforementioned screw connections on the side walls of the slide-in shelf mounting. Such a fixation is time-consuming and thus cost-intensive to manufacture. This is the case because the preparation of a screw connection requires a multitude of individual work steps, each of which is time-intensive. If a slide-in housing is to be fixed by means of a screw connection, then the slide-in housing must be slid with precision into the slide-in shelf mounting until the bores of the slide-in part in the wall of the slide-in shelf mounting correspond to the threaded bores in the slide-in housing. Then, the screw connection has to be established by tightening the screw with multiple rotations of the screw. To achieve a reliable and qualitatively high-value fixation, at least four screw connections per slide-in housing are needed, although it is preferable to provide eight screw connections. With each additional screw connection, the time required for the fixation of the slide-in housing in the slide-in shelf increases.

Document DE 20109697 U1 shows a slide-in mounting for one or more hard disk drives of a computer. The slide-in mounting presents means for attachment in a computer housing, and it comprises attachment means for the attachment of hard disk drive cassettes. Here, on one of two side walls, in the slide-in direction of the drive, spring elements are located one after the other, which project inward, and present pressure at their place that is farthest from the wall. On the opposite side wall of the slide-in mounting, holes are arranged that are provided for the fixation of the drive cassette with screws.

In document DE 29817864 U1, a positioning device for computer writing-reading devices, is shown. This positioning device allows a simple, easy and rapid installation or removal of individual or adjacent data drives, where a single screw is used to position the data drives. In the process, an arched block with a central threaded hole is provided, which is arranged on one of the side walls of the computer housing. On two sides of the slightly arched block, perforating holes are provided, which correspond to positioning holes on the sides of the drives. When the writing-reading device is slid in along sliding rails into the computer housing and positioned therein, an attachment plate with two bent ends is arranged in such a way that the ends of the attachment plate engage through the perforating holes into the positioning holes of the data drives and position this. A screw is then tightened through a central hole of the attachment plate into the central threaded hole of the arched block. In this way, the data drive is positioned.

All these solutions require at least one screw connection to attach a slide-in housing. If a housing for a computer comprises several slide-in mounts to receive slide-in housings, the cost of manufacturing a computer increases in terms of installation.

Mass consumer products, such as computers, are subjected to high price and competition pressure. Therefore, it is of supreme importance for computer manufacturers to remain competitive both with respect to prices and quality. If a screw connection has been omitted without replacement, thus lowering the manufacturing costs of a computer, the quality of the computer might be decreased, and is therefore unsuitable for maintenance of competitiveness.

The objective of the invention is to reduce the time required to install a computer, without a negative effect on the quality of the computer.

### BRIEF DESCRIPTION OF THE INVENTION

A housing for a computer is provided with a slide-in shelf mounting for a slide-in housing with an attachment device, which fixes a slide-in housing of a computer component to a slide-in shelf mounting of a computer housing, and is provided on a side wall of the housing. The attachment device comprises at least one spring-mounted latching bolt, wherein the attachment device is designed to be pre-tensioned, as a result of the insertion of the slide-in housing, pre-tension is applied to the latching bolt, and to hold it there by spring force, after reaching an end position, in a bore of the slide-in housing. The result is that the slide-in housing is fixed in this end position in the slide-in shelf. The fixation of the slide-in housing and the slide-in shaft occurs by means of the latching bolt. Regardless of whether one, two, four or eight latching bolts are provided, the time required to fix the slide-in housing is not increased in any way because all the attachment devices or all the latching bolts are engaged simultaneously in the respective receiving bores provided for that purpose in the slide-in housing.

The spring-mounted attachment of the latching bolt is preferably formed using a longitudinally extended leaf spring element. Thereby, the latching bolt can be arranged at a free end of the leaf spring element. The leaf spring element itself is arranged preferably on the wall of the slide-in shelf, or fixed there in such a way that the latching bolt can be moved back and forth in a single plane parallel to the wall of the housing. By using a leaf spring element, it is possible to use a simple design for this restricted motion capacity because a leaf spring element can be deformed resiliently essentially in only one direction.

The leaf spring element is preferably designed in such a way that it is attached on a swivel axle (a vertical pin), which is arranged perpendicularly with respect to the longitudinal axis in a central area of the leaf spring element, in a manner that allows swiveling or rocking on the wall of the slide-in shelf. Thus, the leaf spring element is arranged so it can swivel about this axle. The result of the arrangement of the axle in the central area of the leaf spring element is that the leaf spring element extends freely on both sides of the swivel axle, wherein the latching bolt is arranged in an area that is at a separation from the swivel axle, in a first end area of the leaf spring element. The result of the capacity to swivel is that it is possible to impart pre-tension to the latching bolt during the installation process, or during the sliding in of the slide-in housing. As a result of this pre-tension, the engagement of the latching bolt occurs more rapidly and more reliably into the bore provided for that purpose on the slide-in housing.

On a second end area of the leaf spring element, which is arranged opposite the first end area, a run-up bevel is preferably provided. The run-up bevel is formed by an obtuse-angle bend of the leaf spring. The obtuse-angle bend allows a simpler application of the pre-tension to the leaf spring element in that a means such as a ramp or protrusion, which is fixed, for example, at the slide-in housing, moves under the leaf spring element on the run-up bevel and thus lifts the leaf spring element at the second end area. As a result of the lifting at this place, via the swivelable attachment, the leaf spring element is lowered onto the opposite first end area, and the leaf spring element and thus the latching bolt receive a pre-tension.

For the reception of slide-in housings that do not present a means that would allow moving under the run-up bevel as in the manner described above, for example, slide-in cards in housings that present on the side walls only threaded bores for attachment, it is preferable to provide a run-up slider ahead of the leaf spring. The run-up slider (actuating lever) can be moved by means of the slide-in housing against the run-up bevel. With the sliding of the slide-in housing into the slide-in shelf mounting, the run-up slider, which is arranged on the slide-in shelf, is shifted against the run-up bevel of the leaf spring element, so that the leaf spring element is raised at the second end area by the run-up slider, and thus receives pre-tension at the first end area or at the latching bolt.

Furthermore, it is preferable to provide a supporting spring element such as a coil spring which acts against the torque generated by the run-up slider in the manner described above. The result is that, in a rest position, when, for example, no slide-in housing is shifted into the slide-in shaft, the leaf spring element is held in a predetermined position by the spring force of the support spring element.

The run-up slider is arranged on the wall of the slide-in shelf preferably in such a way that it can be moved both in a sliding in and sliding out direction. Thus, the run-up slider is moved by the sliding in of the slide-in housing against the run-up bevel, and, during the removal of the slide-in housing, it is moved by means of a spring element, which is provided for that purpose, into its rest position. The rest position of the run-up slider is defined by the position that the run-up slider assumes when the slide-in shaft is empty. During the sliding in of a slide-in housing into the slide-in shelf mounting, the run-up slider is accordingly moved against the spring force of this spring element.

The run-up slider, in a preferred embodiment, presents a catch which is designed so that during the sliding in of the slide-in housing the catch is effectively connected to an element of the slide-in housing. During the sliding in of the slide-in housing into the slide-in shelf, the run-up slider is shifted into its work position in the direction of the run-up bevel. An element of the slide-in housing that acts in this way is, for example, a front panel of the slide-in housing, which presents a gradation at the transition from the slide-in housing to the front panel. At this gradation, the catch of the run-up slider engages. For easy operation and low-force installation of the slide-in housing, the run-up slider is preferably also designed with a run-up bevel. The latter, within the predetermined tolerance range, is formed parallel to the plane of the run-up bevel of the spring element.

### BRIEF DESCRIPTION OF THE DRAWINGS

The invention is explained in greater detail below with the help of an example in reference to two figures.

In the drawings:

FIG. 1 shows an attachment device looking toward the component, and

FIGS. 2A, 2B and 2C show the attachment device in three different installation states.

FIGS. 3A, 3B and 3C show the same installation states in plan view.

FIG. 4 shows the attachment device and shelf as mounted on a cabinet.

### DETAILED DESCRIPTION OF THE INVENTION

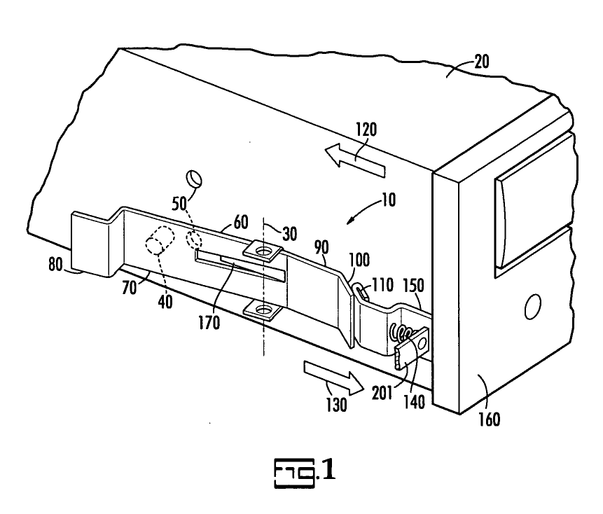

FIG. 1 shows an example of an attachment device 10 with a slide-in component 20. The attachment device 10 is arranged, fixed to the frame on the housing for a computer, or on a side wall of a slide-in shelf or slot of the computer housing. Using a swivel axle (the axis shown as 30), the arrangement, fixed to the frame, is designed so it can be swiveled about the axle. To simplify the view, elements of the slide-in shelf and of the computer housing on which they are mounted are not shown in FIG. 1. The slide-in shelf is designed so that the slide-in component is introduced into it within predetermined measurement tolerances, so that the slide-in component can only be moved into the slide-in shelf or out of the slide-in shelf.

The example of the attachment device 10, which is shown in FIG. 1, presents a latching bolt 40, which engages in a latched state in a bore 50 of the slide-in housing 20. The attachment device 10 is formed from a longitudinally extended leaf spring element 60, which extends freely on both sides of the swivel axle axis 30. The latching bolt 40 is located on a first end area 70 of the leaf spring element 60. In addition, on the first end area 70 of the leaf spring element 60, on which the latching bolt 40 is also arranged, an L-shaped bend 80 is formed. This bend 80 can be used as an operating element. This is suitable for the case where an installed slide-in component 20 is to be moved out of its latching and engagement, and used for disassembly from the slide-in shaft. Using the operating element, which is in the form of the L-shaped bend 80, the latching bolt 40 is lifted by a user, an operator, or an installer, out of the bore 50, and the slide-in housing 20 is released from the engagement or anchoring of the fixation.

A second end area 90 is formed opposite the first end area of the longitudinally extended leaf spring element 60. The second end area 90 presents an obtuse-angle bend 100, which forms a run-up beveled surface 100. During the sliding in of the slide-in housing 20 into the slide-in shelf, a run-up slider 110 is moved under the run-up bevel 100. The run-up slider 110, like the leaf spring element 60, is arranged on the slide-in shelf, wherein the run-up slider 110 is movable in a slide-in direction 120 and a slide-out direction 130. For this purpose, means are provided that restrict the run-up slider 110 to movement in the slide-in direction 120 and in the slide-out direction 130. These means are omitted to simplify the view.

The run-up slider 110 is coupled by spring with a spring element 140 (shown as a coil spring) to the computer housing or the slide-in shaft. The spring element 140 applies a force to the run-up slider 110, which acts on the run-up slider 110 always in the direction of a rest position. If the slide-in shaft is empty, the run-up slider 110 is in this rest position.

The run-up slider 110 preferably presents a catch 150, so that the run-up slider can be moved during the sliding in of the slide-in housing 20 through the housing. The catch 150, as shown in FIG. 1, engaged with a front panel 160 of the slide-in housing, particularly with a protruding edge of the front panel 160 and acts as a stop. During the sliding in of the slide-in housing 20 into the slide-in shaft, the front panel 160 acts on the catch 150, and slides the run-up slider 110 under the run-up bevel 100 of the longitudinally extended leaf spring element 60. As a result, the first end area 70 of the longitudinally extended leaf spring element 60 receives a pre-tension such that after the end position for the slide-in housing 20 is reached, the bolt 40 engages in the bore 50 of the slide-in housing. To allow a clean introduction of the slide-in housing, and to prevent functional disturbances, a punched support spring 170 is provided, which generates a torque so that the longitudinally extended leaf spring element is held in a predetermined position as long as the slide-in housing has not reached the end position. The predetermined position is defined, for example, in such a way that the latching bolt 40 is at a separation from the slide-in housing. It is only when the run-up slider 110 is moved under the run-up bevel 100 of the longitudinally extended leaf spring element 60, that a torque is introduced into the longitudinally extended leaf spring element 60, so that the latching bolt 40 receives pre-tension with a force in the direction of the slide-in housing.

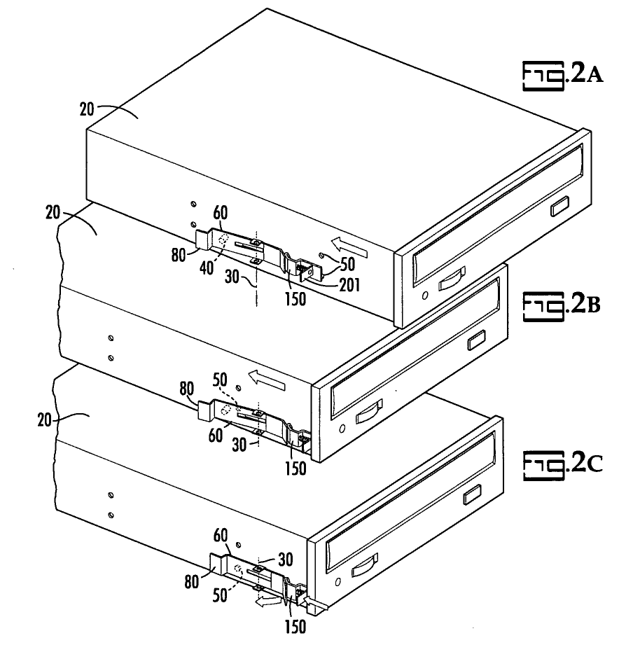

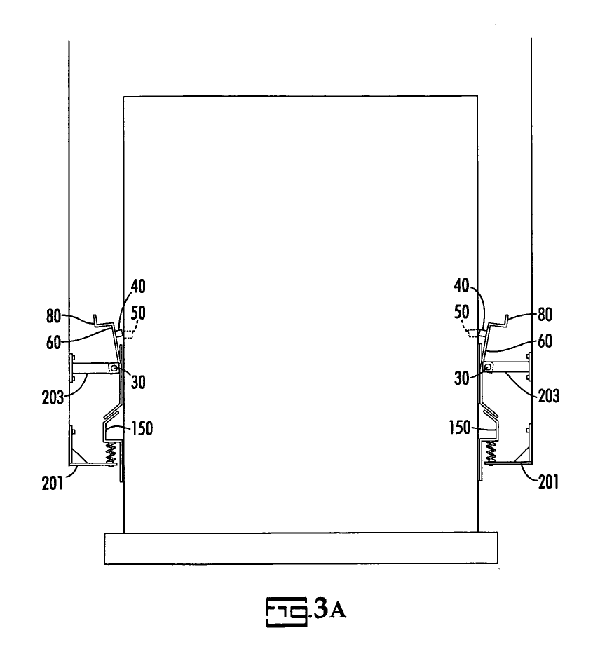

FIGS. 2A with 2B and 2C show, as an illustration of the mechanism of action of the attachment device 10 in three different positions as a slide-in process proceeds to the slide-in housing 20, into the slide-in shelf of the computer housing. FIG. 2A here shows the beginning of the slide-in process, in which both the run-up slider 110 and also the longitudinally extended leaf spring element 60 are in the rest position. The run-up slider 110, in this state, has not yet advanced under the run-up bevel 100, so the support spring element 170 still keeps the bolt 40 at a separation from the slide-in housing 20. The result is the prevention of undesired hooking of the latching bolts 40 during the slide-in process onto elements of the slide-in housing 20, which would prevent the slide-in process.

FIG. 2B shows a position, in which the slide-in housing 20 has already advanced so far into the slide-in shaft that the front panel 160 comes in mechanical contact with the push plate 150 of the run-up slider 110. The longitudinally extended leaf spring element 60 is still unchanged in this position. The run-up slider starts, beginning in this position, its movement in the direction of the run-up bevel 100 of the longitudinally extended leaf spring element 60.

In FIG. 2C, the run-up slider 110, via the protrusion of the front panel in effective connection with the catch 150, has been inserted under the run-up bevel 100. As a result, the longitudinally extended leaf spring element 60 has performed a rotation. This rotation has the effect of applying pre-tension to the bolt 40. When reaching the end position, which is shown in FIG. 2C, the latching bolt 40 engages in the bore 50. The rotation of the longitudinally extended leaf spring element 60 here occurs about the swivel axle 30. This position defines the work position for the attachment device 10. In this position, the latching bolt 40 is engaged in the bore 50. The latching device 10 fixes the slide-in housing 20 with the bolt 40 in this position in the slide-in shaft.

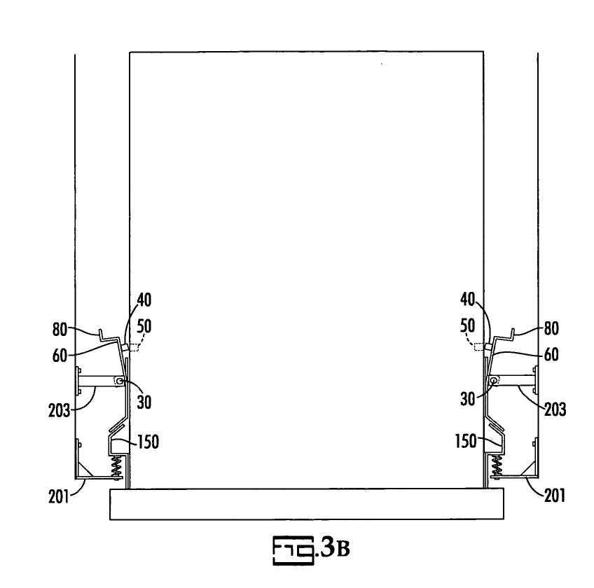

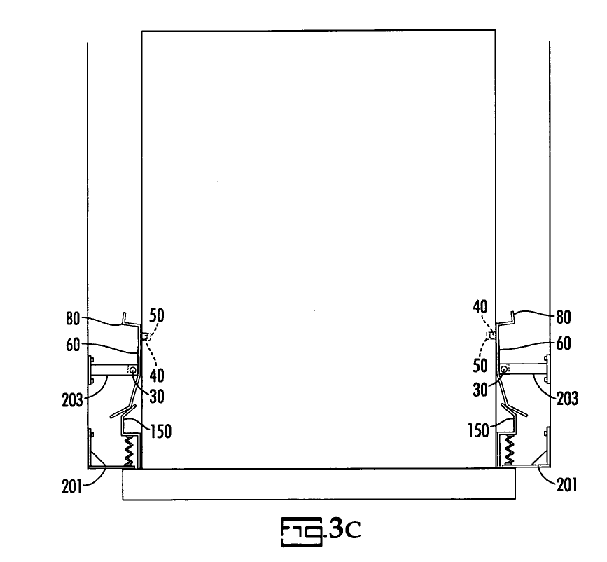

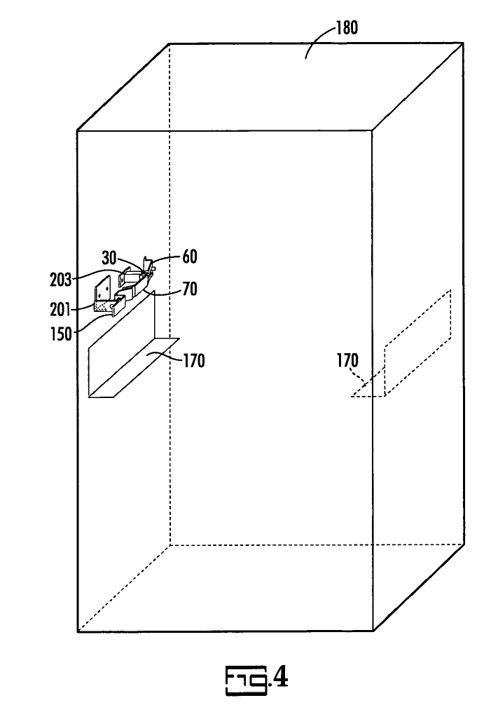

FIGS. 3A, 3B and 3C illustrate the insertion process in plan view, showing final engagement of bolt 40 into hole 50 which locks the component into position. These Figures show the location of the axle along the axis 3C and the standoffs from the housing to support the axle (203) and the coil spring 140 (201).

FIG. 4 illustrates the location of the attachment device 10 in the housing 180 with respect to shelf 190.

To improve the quality of the fixation in the slide-in shaft, a plurality of the described attachment devices can be used, without increasing the time required for the installation of the slide-in housing. This is the case because all the attachment devices engage identically when the end position of the slide-in housing is reached. Thus, using the described attachment device, a high-quality attachment which does not take more time can be achieved.

### LIST OF REFERENCE NUMERALS

| | |
|---|---|
| 10 | Attachment device |
| 20 | Slide-in housing |
| 30 | Swivel axle |
| 40 | Latching bolt |
| 50 | Bore |
| 60 | Leaf spring element |
| 70 | First end area of the leaf spring element |
| 80 | L-shaped bend |
| 90 | Second end area |
| 100 | Obtuse-angle bend/run-up bevel |
| 110 | Run-up slider |
| 120 | Slide-in direction |
| 130 | Slide-out direction |
| 140 | Support spring element |
| 150 | Push Plate |
| 160 | Front panel |
| 170 | Support spring |
| 190 | Slide in shelf |
| 201 | Standoff for spring |
| 203 | Standoff for axle |

1. Mounting for a computer component with a slide-in shelf for a slide-in component housing, said housing for a computer comprising:
an attachment device arranged on a side wall of the slide-in shelf, which fixes said slide-in component housing in said slide-in shelf,
said attachment device comprising
a spring-mounted latching bolt, whereby the attachment device is designed to apply pre-tension to said latching bolt as a result of the insertion of the slide-in housing into the slide-in shelf and to hold it by spring force when an end position is reached in a bore of said slide-in component housing.

2. Mounting for a computer component according to claim 1 wherein said latching bolt is mounted on a leaf spring element.

3. Mounting for a computer component according to claim 2 wherein said leaf spring element is attached on a swivel axle which is aligned perpendicular to the longitudinal axis of leaf spring element in such a way that said leaf spring element swivels on the wall of said slide-in shelf so that the leaf spring element extends on both sides of said swivel axle and said latching bolt is arranged at a first end area of said leaf spring element.

4. Mounting for a computer component according to claim 3 wherein said first end area of said leaf spring element terminates in an L-bend.

5. Mounting for a computer component according to claim 3 wherein a second area of leaf spring element includes an angle run-up bevel formed from an obtuse bend in the second end area.

6. Mounting for a computer component according to claim 5 comprising a run-up slider moveable mounted under said run-up bevel whereby said run-up slider is designed to be moved by means of said slide-in component housing so that the run-up bevel is lifted from said run-up slider.

7. Mounting for a computer component according to claim 6 comprising a support spring element (170) whose spring force counteracts a torque that is generated by the movement of the run-up slider on the first end area.

8. Mounting for a computer component according to claim 6 wherein a spring element (140) mounted on a standoff attached to the housing for a computer, urges said run-up slider to maintain contact with said means of said slide-in component housing.

9. Mounting for a computer component according to claim 5 whereby the run-up slider comprises a push plate which moves said run-up slider by means of the slide-in housing.
